(19) United States
(12) Patent Application Publication
(10) Pub. No.: US 2011/0276691 A1
(43) Pub. Date: Nov. 10, 2011

(54) Methods and Systems of Forming the Uniform Resource Identifier of An Arbitrary Segment of A Resource

(76) Inventors: Lianghwa Jou, Hillsborough, CA (US); Nara Rajagopalan, Los Altos Hills, CA (US)

(21) Appl. No.: 12/776,439

(22) Filed: May 10, 2010

(51) Int. Cl. G06F 15/16

(52) U.S. Cl. 709/226; 709/245

(57) ABSTRACT

This disclosure relates to methods and systems of forming the Uniform Resource Identifier (URI) of an arbitrary segment of a resource without the FRAGMENT component, and generally comprising the steps of devising a logical framework for the resource and formulating an addressing scheme and reverse-addressing scheme for any arbitrary segment of the resource. Embodiments of the general methods and systems may include attaching information regarding the subject matter of the segment of the resource to the corresponding URI, and forming a composite URI for multiple component segments of one or more resources without the need to physically combine the component segments.

### BACKGROUND

This disclosure relates to the field of forming the Uniform Resource Identifier (URI) of an arbitrary segment of contents of a resource, and its applications. A URI is a string of characters that identifies a resource, with the syntax of the URI complying with a set of uniform specifications applicable across various devices, access mechanisms, and types of resources. The URI specifications have historically developed in connection with the development of the internet, and have been widely accepted as the primary identifier for the internet, although their applications need not be limited to network settings. These specifications are defined and discussed in a series of Requests for Comments (RFC) published by the Internet Engineering Task Force (IETF), which is an internet steering body composed of representatives from various groups working in the internet arena. Based on the RFCs, IETF has reduced the URI specifications to a set of guidelines referred to as the Best Current Practice (BCP). The most current RFC on the syntax of URIs is RFC 3986.

The types of resources that can be identified by a URI may include, but not limited to, ASCII text documents, PDF documents, images, audio/video clips, web pages, e-mails, data bases, application scripts, service gateways, etc. Some of the common examples of URIs are: http://www.example.com/index.html (web page); ftp://ftp.example.org/public/download.txt (document files); mailto: JohnDoe@example.com (e-mails); tel:+1-888-888-8888 (telephone calls); etc.

A URI can be used to identify not only a full complete resource (for example, a text file), but also a segment of a resource (for example, a paragraph of a text file). In the latter case, the segment is conventionally identified by a portion of the URI character string referred to as a “FRAGMENT”. In the network context, URIs are searchable by search engines, such as google or yahoo, which also archive the contents of the resources identified by the corresponding URIs. A segment of resource identified by a URI “FRAGMENT”, however, currently is not searchable by the search engines. Furthermore, it is currently not viable to attach multiple-hierarchy information regarding the segment to the URI via the “fragment”.

### SUMMARY

The first aspect of the invention features a method of forming the Uniform Resource identifier (URI) of an arbitrary segment of a resource, without using the FRAGMENT component. The method first receives information regarding a resource, and then devises a logical framework for the resource according to the information regarding the resource. The logical framework assigns a reference identifier to an arbitrary segment of the resource according to a set of segment information of the segment, and converts a reference identifier assigned to a segment of the resource to the corresponding set of segment information. The method next formulates an addressing scheme that translates the reference identifier assigned to a segment of the resource under the logical framework to a corresponding URI, without using the FRAGMENT component. In a further step, the method formulates a reverse-addressing scheme for the resource that converts the URI of a segment of a segment of the resource formed according to the addressing scheme into the corresponding reference identifier. The logical framework, the addressing scheme, the reverse-addressing scheme and their mutual associations are then stored.

Embodiments of the first aspect of the invention may include one or more of the following features. In one embodiment, the addressing scheme and the reverse-addressing scheme may use computer-implemented algorithms to convert between reference identifiers and the corresponding URIs.

In another embodiment, the addressing scheme and the reverse-addressing scheme may store mapping relations between reference identifiers of multiple segments of the resource and the corresponding URIs in one or more look-up data stores.

In another embodiment, the addressing scheme and the reverse-addressing scheme may use combinations of computer-implemented algorithms and discrete mapping relations stored in one or more look-up data stores.

In another embodiment, the set of segment information for a segment of the resource may comprise two components, the first component being necessary to identify the segment and the second component being additional to the first component. Furthermore, the set of segment information may be stored and retrieved by accessing the corresponding URI.

In another embodiment, the resource may be a digital multimedia document and the URIs formulated according to the addressing scheme may include a first component that comprise subject matter information of the segment and a second component that comprise the beginning time and duration, or alternatively the ending time, of the segment.

The second aspect of the invention features a method of forming a composite URI for multiple segments of one or more resources without using the FRAGMENT component. The method first receives from one or more applications a plurality of component URIs corresponding to a plurality of component segments of one or more resources and an access sequence of the component segments. Next the method formulates a composite addressing scheme that translates the plurality of component URIs into a composite URI, which incorporates the access sequence and is composed without the FRAGMENT component. Next the method formulates a composite reverse-addressing scheme, which converts a composite URI formed according to the composite addressing scheme into the corresponding plurality of component URIs and the corresponding access sequence. The component URIs, the composite addressing scheme, the composite reverse-addressing scheme, the composite URI, and their mutual associations are then stored.

Embodiments of the second aspect of the invention may include one or more of the following features. In one embodiment, the one or more resources are digital multimedia documents.

The third aspect of the invention features a system of forming the Uniform Resource identifier (URI) of an arbitrary segment of a resource, without using the FRAGMENT component. The system is comprised of one or more processing units operable of (1) receiving from one or more applications requests and information regarding a resource and segments of the resource; (2) devising a logical framework for the resource, the logical framework assigning a reference identifier to an arbitrary segment of the resource according to a set of segment information of the segment and converting a reference identifier assigned to a segment of the resource to the corresponding set of segment information; (3) formulating an addressing scheme that translates the reference identifier assigned to a segment of the resource under the logical framework to a corresponding URI, without using the FRAGMENT component; (4) formulating a reverse-addressing scheme for the resource that converts the URI of a segment of a segment of the resource formed according to the addressing scheme into the corresponding reference identifier; and (5) storing the logical framework, the addressing scheme, the reverse-addressing scheme and their mutual associations in one or more data stores.

The fourth aspect of the invention features a system of forming a composite URI for multiple segments of one or more resources without using the FRAGMENT component. The system is comprised of one or more processing units operable of (1) receiving from one or more applications a plurality of component URIs corresponding to a plurality of component segments of one or more resources and an access sequence of the component segments; (2) formulating a composite addressing scheme that translates the plurality of component URIs into a composite URI, which incorporates the access sequence and is composed without the FRAGMENT component; (3) formulating a composite reverse-addressing scheme, which converts a composite URI formed according to the composite addressing scheme into the corresponding plurality of component URIs and the corresponding access sequence; (4) storing the component URIs, the composite addressing scheme, the composite reverse-addressing scheme, the composite URI, and their mutual associations in one or more data stores.

### BRIEF DESCRIPTION OF THE DRAWINGS

FIG. 1.a Schematic and flow diagrams of the system and process of forming the URI of a segment of a resource, part 1 (formulating the general framework and schemes);

FIG. 1.b Schematic and flow diagrams of the system and method of forming the URI of a segment of a resource, part 2 (forming a target URI);

FIG. 1.c Schematic and flow diagrams of the system and method of forming the URI of a segment of a resource, part 3 (accessing an input URI);

FIG. 2.a Schematic and flow diagrams of the system and process of forming a composite URI for multiple component segments, part 1 (formulating the schemes and forming a composite URI);

FIG. 2.b Schematic and flow diagrams of the system and process of forming a composite URI for multiple component segments, part 2 (accessing an input composite URI).

### DETAILED DESCRIPTION

### A. Introduction

This disclosure relates to the method and system of forming the Uniform Resource Identifier (URI) of an arbitrary segment of a resource, and their applications. A URI is represented by a string of characters that comply with a set of uniform syntaxes. As defined in Request for Comments (RFC) 3986 published by the Internet Engineering Task Force, the generic syntax of a URI comprises the following components and hierarchy:
SCHEME://AUTHORITY/PATH?QUERY#FRAGMENT

In the above generic URI syntax, the five components: SCHEME, AUTHORITY, PATH, QUERY, and FRAGMENT are separated by the characters “//”, “/”, “?”, and “#”, respectively. The first component, SCHEME, identifies the particular scheme design of the URI; the second component, AUTHORITY, identifies the resource that is responsible within the SCHEME design for parsing the remaining portion of the URL; the third component, PATH, represents the hierarchical data, which, combined with the data represented by the non-hierarchical component, QUERY, identify the primary resource corresponding to the URI; and the fifth and last component, FRAGMENT, identifies a secondary resource with respect to the primary resource identified by the components PATH and QUERY. Except for the SCHEME component, all of the components do not have to be present in a URI. Some common examples of URIs are:
http://www.example.com/index.html (web page);
ftp://ftp.example.org/public/download.txt (document files);
http://ftp.example.com:80/textbook.html#Chapterl (segment of a web page);
mailto: JohnDoe@example.com (e-mails);
tel:+1-888-888-8888 (telephone calls);

A secondary resource, as discussed in the last paragraph, can be a sub-set or a portion of the primary source; a specific representation of the primary resource; or a separate resource defined or described by the primary resource. (See, e.g., RFC 3986 §3.5.) In this disclosure, the term “segment” is used equivalently and interchangeably with the term “secondary resource”. With this terminology in mind, in the generic URI syntax described above, such a segment of a resource (or secondary resource of a primary resource) is generally represented by the FRAGMENT component. During a retrieval action referenced from a URI, the FRAGMENT component described above is generally separated from the other components and not considered a part of the URI. (See, e.g., RFC 2396§4.1.) This attribute of the FRAGMENT component presents certain disadvantages in practical applications of the generic URI syntax design.

### B. Forming the URI of a Segment without the Fragment Component

This disclosure provides alternative systems and processes for forming the URI of a segment of a resource without the FRAGMENT component.

### B.1. Logical Framework, Addressing Scheme, & Reverse-Addressing Scheme

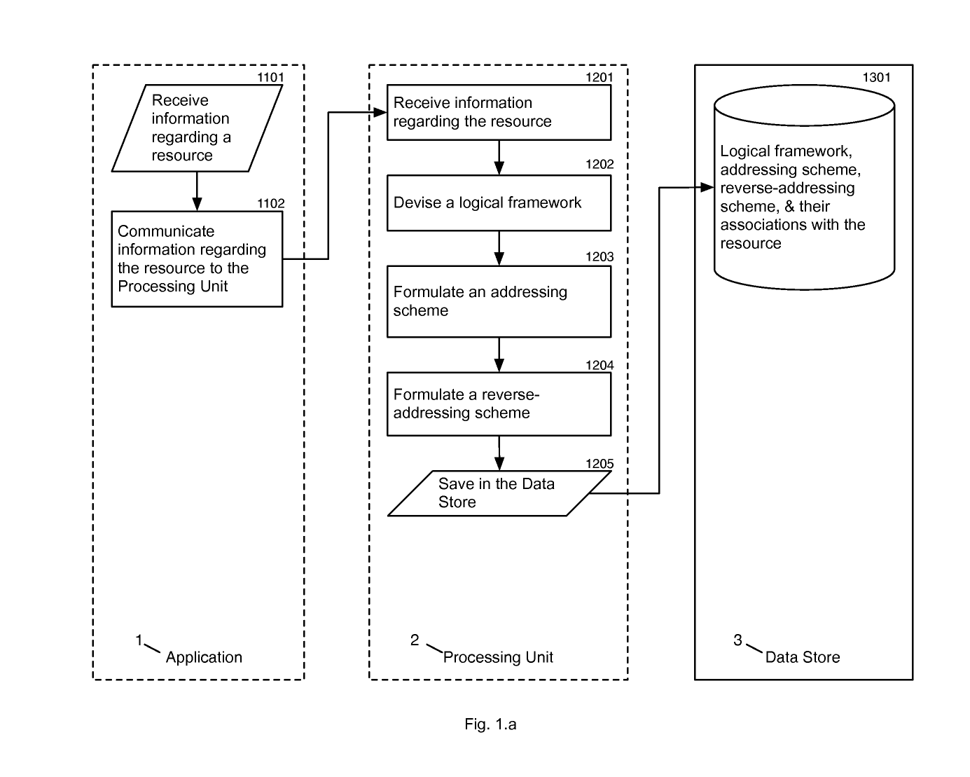

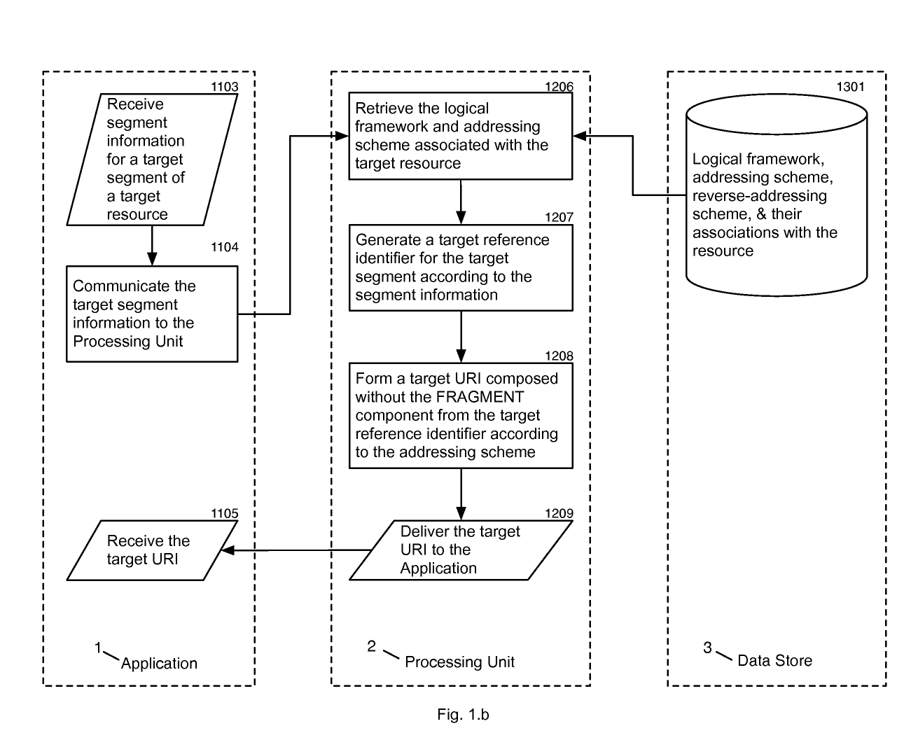

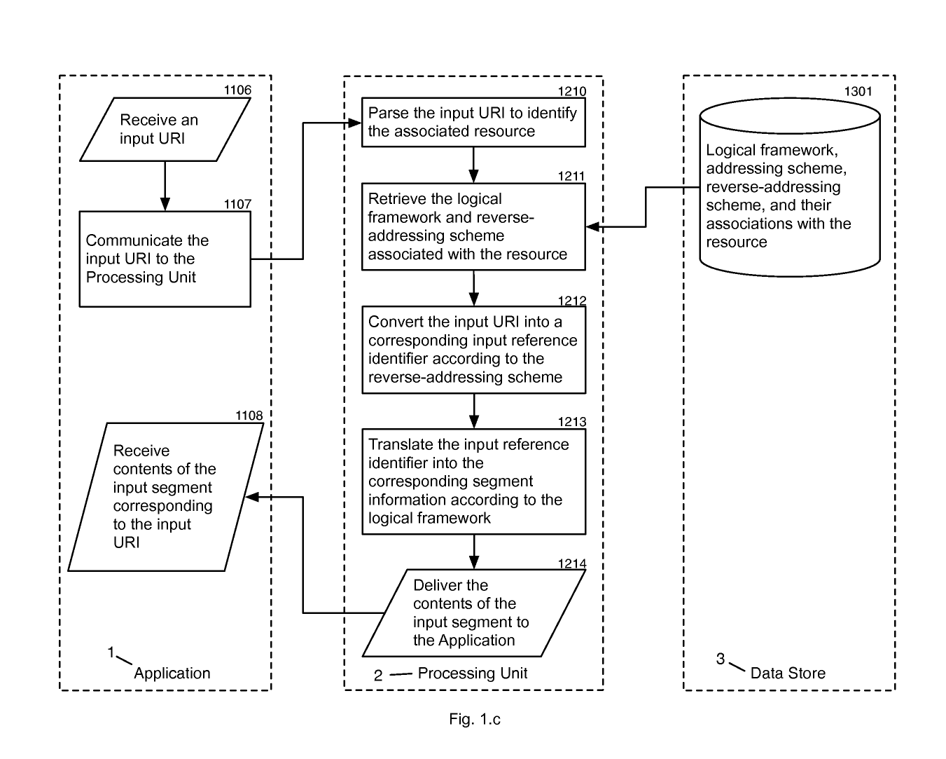

In the general embodiment, referring to FIG. 1.a, one or more applications (“Application” 1) receive information regarding a resource 1101, and communicate the information to one or more processing units (“Processing Unit”) 1102. The Processing Unit 2 receives the information regarding the resource 1201 and devises a logical framework for identifying any arbitrary segment of the resource 1202. The logical framework assigns a reference identifier to a segment of the resource according to a set of segment information necessary to identify the segment. Furthermore, a reference identifier can be converted back to the corresponding set of segment information via the logical framework. As an example for demonstration purposes only, referring to a text document, the full text document may be assigned the reference identifier RI-Text001P000, whereas a segment that includes the 5^{th} paragraph of the texts may be assigned the reference identifier RI-Text001P005. As an additional example, for an audio/video (A/V) clip having a total duration of 5 minutes and 35 seconds, the segment of the A/V clip beginning at time 3:03 and ending at time 4:10 can be assigned a reference identifier RI-AV001B00183D0067, which indicates that the segment begins at the 183^{rd} second for a duration of 67 seconds. Conversely, referring to the same examples, the reference identifier RI-Text001P005 can be translated to identify the 5^{th} paragraph of the corresponding text document, and RI-AV001B00183D0067 can be translated to identify the segment of the A/V clip beginning at 3:03 and ending at 4:10.

Having devised the logical framework, the Processing Unit 2 next formulates an addressing scheme to translate a reference identifier assigned by the logical framework into a corresponding URI, composed without the FRAGMENT component 1203. Continuing with the examples cited above, for demonstration purposes only, the reference identifier RI-Text001P005 assigned to the 5^{th} paragraph of the text document can be translated into the URI “ftp://ExampleFTPServer/Txt001P005”. On the other hand, the reference identifier RI-AV001B00183D0067 for the 67-second A/V segment, can be translated into either of the following example URIs: “http://www.example.com/AV001B00183D0067”, or “ExScheme://ExServer/AV001B00183E00250” (250 being the ending time in seconds), or “example.com/AV001B00183D0067”.

In a further step, the Processing Unit 2 formulates a reverse-addressing scheme to convert a URI formed according to the addressing scheme into the corresponding reference identifier 1204. Continuing with the examples cited above, for demonstration purposes only, the reverse-addressing scheme for the text document can convert the URI “ftp://ExampleFTPServer/Txt001P005” into the reference identifier RI-Text001P005, and the reverse-addressing scheme for the A/V clip can convert the URI “example.com/AV001B00183D0067” into the reference identifier RI-AV001B00183D0067.

The logical framework, the addressing scheme, and the reverse addressing scheme are then stored in one or more data stores (“Data Store” 3) accessible by the Processing Unit 2, with indications of the associations between the logical framework, the addressing scheme, the reverse-addressing scheme, and the resource 1205.

### B.2. Forming an Individual URI

Continuing with the general embodiment, the Processing Unit 2 can subsequently form the URI for any segment of the resource by accessing the stored framework and schemes. Referring to FIG. 1.b, the Application 1 receives a set of information of a target segment of a resource 1103 and communicates the set of target segment information to the Processing Unit 1104. The Processing Unit 2 then retrieves the logical framework and the addressing scheme associated with the resource 1206; generates a reference identifier for the target segment according to the target segment information and the logical framework 1207; and forms a target URI from the target reference identifier according to the addressing scheme 1208. The target URI is then delivered to the Application 1209.

As an example for demonstration purposes only, an internet application (the Application 1) receives a request to form a URI for a segment of an A/V clip, the segment beginning from the 183^{rd} second of the clip and lasting 67 seconds. The application communicates the beginning time and duration information to a computer server (the Processing Unit 2), which retrieves form its databases (the Data Store 3) the logical framework and addressing scheme associated with the A/V clip, and assigns the reference identifier “AV001B00183D0067” to the segment. The reference identifier is then translated to the URI “example.com/AV001B00183D0067” according to the addressing scheme, which is delivered to the internet application.

### B.3. Accessing a URI

Continuing with the general embodiment, the Application 1 can access a segment of a resource by accessing the corresponding URI. Referring to FIG. 1.c, the Application 1 receives an input URI 1106, generated according to the addressing scheme described above, and communicates the input URI to the Processing Unit 1107. After parsing the input URI to identify the associated resource 1210, the Processing Unit 2 retrieves the logical framework and reverse-addressing scheme associated with the resource 1211, and converts the input URI into the corresponding input reference identifier according to the reverse-addressing scheme 1212. The input reference identifier is then translated into the corresponding set of segment information according to the logical framework 1213. The Processing Unit 2 then delivers the contents corresponding to the set of segment information to the Application 1214.

As an example for demonstration purposes only, an internet application (the Application 1) receives the input URI “example.com/AV001B00183D0067” and communicates the input URI to the computer server “example.com” (the Processing Unit 2). The computer server parses the input URI and identifies the URI to be associated with the A/V clip “AV001”. The computer server then retrieves the logical framework and reverse-addressing scheme associated with AV001 and converts the input URI to the reference identifier RI-AV001B00183D0067 according to the reverse-addressing scheme. In the next step, the reference identifier is translated to the corresponding set of segment information (beginning time, 183^{rd} second, and duration, 67 seconds). In the final step, the computer server delivers the contents of the A/V clip beginning from the 183^{rd} second and lasting 67 seconds to the internet application.

### C. Other Example Embodiments

In embodiment #2, the addressing scheme and the reverse-addressing scheme disclosed in the general embodiment use computer-implemented algorithms to translate a reference identifier assigned by the logical framework to a URI and to convert a URI into the corresponding reference identifier.

In embodiment #3, the addressing scheme and the reverse-addressing scheme use look-up tables to translate a reference identifier to a URI and to convert a URI into the corresponding reference identifier. The look-up tables store mapping relations between a discrete set of reference identifiers and the corresponding URIs.

In embodiment #4, the addressing scheme and the reverse-addressing scheme use combinations of computer-implemented algorithms and look-up tables to translate a reference identifier to a URI and to convert a URI into the corresponding reference identifier. The look-up tables store mapping relations between a discrete set of reference identifiers and the corresponding URIs.

In embodiment #5, the set of information of a segment of a resource as described in the general embodiment comprises two components. One of the components is necessary to identify the contents of the segment, and the other component comprises additional information not necessary to identify the contents of the segment. As an example for demonstration purposes only, referring to FIG. 1.b, an internet application (the Application 1) receives a request to form the URI of a target segment of an A/V clip. The internet application also receives a set of information of the target segment comprising two parts 1103. The first part of the target segment information consists of the beginning time (183^{rd} second) and the duration (67 seconds), which are necessary to identify the target A/V segment. Additionally, the second part of the target segment information includes the title of the target segment (“MJ Moon Walking”). The internet application communicates the set of target segment information to a computer server (the Processing Unit 2) 1104, which then retrieves the associated logical framework and addressing scheme 1206. According to the logical framework, the computer server assigns to the target segment the target reference identifier “RI-MJ001B00183D0067” 1207, which is then converted to the target URI “example.com/MJ001B0083D0067” according to the addressing scheme 1208. Furthermore, the computer server stores the title of the target segment “MJ Moon Walking” in a look-up database (the Data Store 3) along with the target URI. If the target URI is accessed subsequently, becoming the input URI in FIG. 1.c, the computer server will deliver to the requesting application not only the contents of the segment associated with the URI, but also the title texts “MJ Moon Walking” 1214.

In embodiment #6, the additional component of a set of segment information not necessary to identify the segment, as described in embodiment #5, is incorporated directly into the URI, instead of being stored in a look-up database. Using the preceding example for demonstration purposes only, the URI for the A/V segment having a title of “MJ Moon Walking” is formed as “example.com/MJ001MJMoonWalkingB0083D0067”.

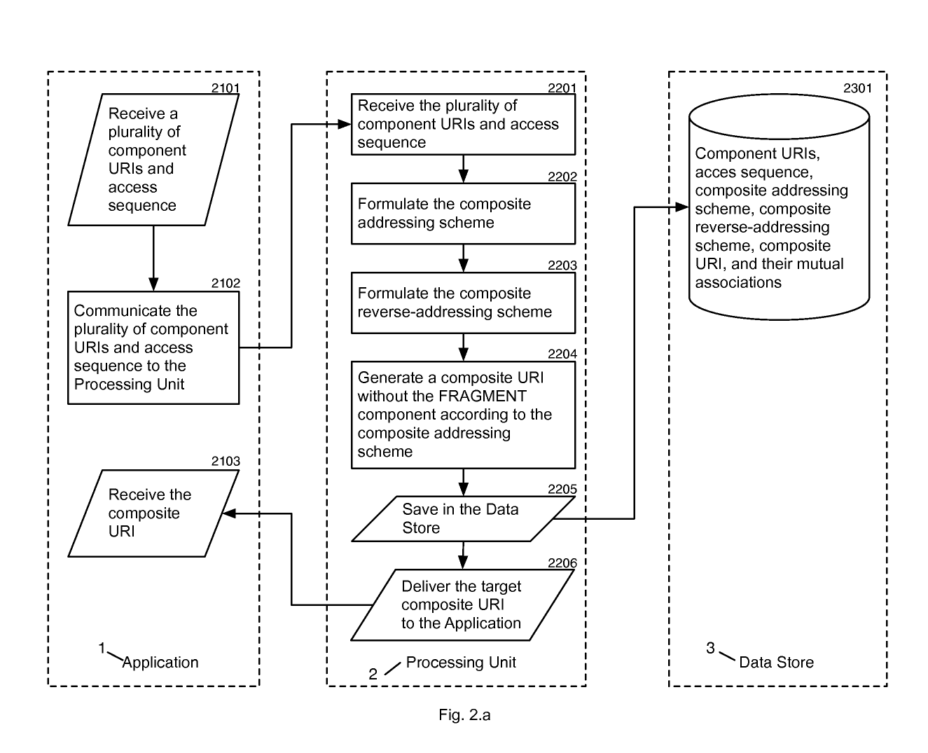

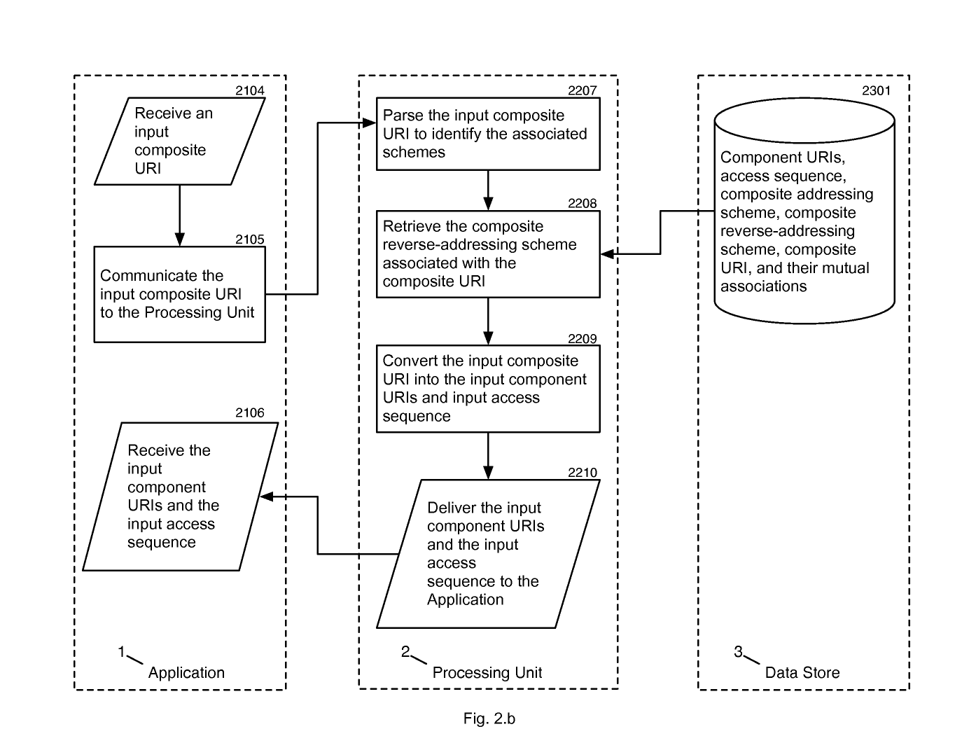

In embodiment #7, a URI without the FRAGMENT component is formed to virtually represent multiple segments of one or more resources, without the need to physically combine the component segments. Referring to FIG. 2.a and FIG. 2.b, the Processing Unit 2 receives a request to form a composite URI for multiple component URIs, corresponding to multiple component segments of one or more resources 2201. The Processing Unit 2 then formulates a composite addressing scheme 2202 and a composite reverse addressing scheme 2203 associated with the request. The composite addressing scheme generates a composite URI, composed without the FRAGMENT component, for the component URIs according to a pre-determined access sequence among the component URIs 2204. The composite reverse-addressing scheme, on the other hand, converts a composite URI formed according to the composite addressing scheme into its component URIs and their access sequence 2209.

As an example for demonstration purposes only, an internet application (the Application 1) receives a request to form a composite URI for two A/V segments having the respective URIs “example1.com/MJ001B00183D067” (component segment #1) and “example2.com/AVClip001.mpg” (component segment #₂). Furthermore, the internet application also receives an instruction to display the component segment #2 before the component segment #1 2101. The internet application forms a request, which includes among others the component URIs and the access sequence, and communicates the request to a computer server (the Processing Unit 2) 2102. The computer server then formulates a composite addressing scheme 2202 and a composite reverse-addressing scheme 2203 corresponding to the request. In the next step, the composite addressing scheme generates the composite URI “example.com/12345” for the request 2204 and stores the composite URI and the request, which includes among others the component URIs and the access sequence, in a look-up database (the Data Store 3) 2205. When the composite URI is subsequently accessed, the computer server receives a request to deliver the contents associated with the composite URI. In response to the request, the computer server retrieves from the look-up database the composite reverse-addressing scheme 2208, converts the composite URI into the input component URIs and the access sequence 2209, and delivers them to the requesting application 2210. The requesting application then access the content of the component segments by accessing the component URIs according to the access sequence.

Furthermore, the composite addressing scheme and the composite reverse-addressing scheme may comprise computer-implemented algorithms, instead of look-up databases, or the combinations of algorithms and look-up databases.

The embodiments and examples disclosed in this disclosure are for demonstration and illustration purposes only, and do not and should not be construed to limit the scope of this disclosure to the embodiments and examples only.

We claim:

1. A computer-implemented method of forming the Uniform Resource Identifier (URI) of a segment of a resource, comprising the steps of:
i. receiving information regarding a resource;
ii. devising a logical framework for the resource according to the information regarding the resource, wherein the logical framework assigns a reference identifier to an arbitrary segment of the resource according to a set of segment information of the segment, and converts a reference identifier assigned to a segment of the resource to the corresponding set of segment information, said set of segment information sufficiently identifying the segment;
iii. formulating an addressing scheme for the resource, wherein the addressing scheme translates a reference identifier assigned to a segment of the resource under the logical framework to a corresponding URI, said URI being composed without the FRAGMENT component;
iv. formulating a reverse-addressing scheme for the resource, wherein the reverse-addressing scheme converts the URI of a segment of the resource formed according to the addressing scheme into the corresponding reference identifier, said reference identifier being compatible with the logical framework;
v. storing the logical framework, the addressing scheme, the reverse-addressing scheme, and their mutual associations with the resource;

2. The method of claim 1, wherein the addressing scheme and the reverse-addressing scheme comprise computer-implemented algorithms;

3. The method of claim 1, wherein the addressing scheme and the reverse-addressing scheme comprise discrete mapping relations between reference identifiers of multiple segments of the resource and the corresponding URIs, said mapping relations being stored in one or more look-up data stores.

4. The method of claim 1, wherein the addressing scheme and the reverse-addressing scheme comprise combinations of computer-implemented algorithms and discrete mapping relations between reference identifiers of multiple segments of the resource and the corresponding URIs, said mapping relations being stored in one or more look-up data stores;

5. The method of claim 1, wherein the set of segment information for a segment of the resource comprises a first component necessary to identify the segment and a second component additional to the first component; and wherein the set of segment information is stored and retrievable by accessing the corresponding URI.

6. The method of claim 5, wherein the resource is a digital multimedia document and the URIs formulated according to the addressing scheme comply with the format: SCHEME://AUTHORITY/PATH; wherein the component, PATH, further comprises a first component comprising subject matter information of the segment and a second component comprising the beginning time and the duration, or alternatively the ending time, of the segment.

7. A computer-implemented method of forming the URI of multiple segments of one or more resources, comprising the steps of:
i. receiving a plurality of component Uniform Resource Identifiers (URIs) corresponding to a plurality of component segments of one or more resources, and an access sequence of the component segments;
ii. formulating a composite addressing scheme, wherein the composite addressing scheme translates the plurality of component URIs into a composite URI, wherein said composite URI incorporates the access sequence and is composed without the FRAGMENT component;
iii. formulating a composite reverse-addressing scheme, wherein the composite reverse-addressing scheme converts a composite URI formed according to the composite addressing scheme into the corresponding plurality of component URIs and the corresponding access sequence;
iv. storing the component URIs, the composite addressing scheme, the composite reverse-addressing scheme, the composite URI, and their mutual associations;

8. The method of claim 7, wherein the one or more resources are digital multimedia documents.

9. A system of forming a Uniform Resource Identifier (URI) of a resource, comprising one or more processing units operable of:
i receiving from one or more applications requests and information regarding a resource and segments of the resource, said one or more applications being operable of receiving information and communicating with the processing units;
ii devising a logical framework for the resource, wherein the logical framework assigns a reference identifier to an arbitrary segment of the resource according to a set of segment information of the segment, and converts a reference identifier assigned to a segment of the resource to the corresponding set of segment information, said set of segment information sufficiently identifying the segment;
iii formulating an addressing scheme for the resource, wherein the addressing scheme translates a reference identifier assigned to a segment of the resource under the logical framework to a corresponding URI, said URI being composed without the FRAGMENT component;
iv formulating a reverse-addressing scheme for the resource, wherein the reverse-addressing scheme converts the URI of a segment of the resource formed according to the addressing scheme into the corresponding reference identifier, said reference identifier being compatible with the logical framework;
v storing in one or more data stores the logical framework, the addressing scheme, the reverse-addressing scheme, and their mutual associations with the resource, said one or more data stores being accessible by the one or more processing units;

10. The system of claim 9, wherein the addressing scheme and the reverse-addressing scheme comprise computer-implemented algorithms;

11. The system of claim 9, wherein the addressing scheme and the reverse-addressing scheme comprise discrete mapping relations between reference identifiers of multiple segments of the resource and the corresponding URIs, said mapping relations being stored in one or more look-up data stores.

12. The system of claim 9, wherein the addressing scheme and the reverse-addressing scheme comprise combinations of computer-implemented algorithms and discrete mapping relations between reference identifiers of multiple segments of the resource and the corresponding URIs, said mapping relations being stored in one or more look-up data stores;

13. The system of claim 9, wherein the set of segment information for a segment of the resource comprises a first component necessary to identify the segment and a second component additional to the first component; and wherein the set of segment information is stored and retrievable by accessing the corresponding URI.

14. The system of claim 13, wherein the resource is a digital multimedia document and the URIs formulated according to the addressing scheme comply with the format: SCHEME://AUTHORITY/PATH; wherein the component, PATH, further comprises a first component comprising subject matter information of the segment and a second component comprising the beginning time and the duration, or alternatively the ending time, of the segment.

15. A system of forming the URI of multiple segments of one or more resources, comprising one or more processing units operable of:
i. receiving from one or more applications a plurality of component Uniform Resource Identifiers (URIs) corresponding to a plurality of component segments of one or more resources, and an access sequence of the component segments, said one or more applications being operable of receiving information and communicating with the processing units;
ii. formulating a composite addressing scheme, wherein the addressing scheme translates the plurality of component URIs into a composite URI, wherein said composite URI incorporates the access sequence and is composed without the FRAGMENT component;
iii. formulating a composite reverse-addressing scheme, wherein the composite reverse-addressing scheme converts a composite URI formed according to the composite addressing scheme into the corresponding plurality of component URIs and access sequence;
iv. storing in one or more data stores the plurality of component URIs, composite addressing scheme, the composite reverse-addressing scheme, the composite URI, and their mutual associations, said one or more data stores being accessible by the one or more processing units;

16. The system of claim 15, wherein the one or more resources are digital multimedia documents.
